(19) United States
(12) Patent Application Publication
(10) Pub. No.: US 2015/0216367 A1
(43) Pub. Date: Aug. 6, 2015

(54) HAND SANITIZING DISPENSING DEVICE

(71) Applicant: Benjamin Arana Barbier, Weston, MA (US)

(72) Inventor: Benjamin Arana Barbier, Weston, MA (US)

(21) Appl. No.: 14/588,588

(22) Filed: Jan. 2, 2015

Related U.S. Application Data
(60) Provisional application No. 62/060,785, filed on Oct. 7, 2014.
(60) Provisional application No. 61/956,199, filed on Jan. 7, 2014.

(51) Int. Cl. A47K 5/12; B05B 15/06; B05B 11/00

(52) U.S. Cl. CPC A47K 5/1201; B05B 11/3052; B05B 11/3001; B05B 15/061; A47K 5/1211

(57) ABSTRACT

A dispenser including a housing for containing a reservoir that can store a substance. The housing can include two large opposed spaced apart curved hand actuation surfaces at opposite sides of the housing for engaging opposite sides of the user's palm of the hand when squeezed that are capable of moving towards and away from each other generally along an actuation path. A pump can be connected to and actuated by at least one of the curved hand actuation surfaces for pumping the substance from the reservoir. The pump can include a nozzle positioned in a generally central location of the housing between the two opposed curved hand actuation surfaces and aimed transversely outwardly relative to the front surface of the housing for ergonomic delivery of the substance to a central location of the user's palm of the hand while ergonomically squeezing the two opposed hand actuation surfaces.

### RELATED APPLICATIONS

This application claims the benefit of U.S. Provisional Application Nos. 62/060,785, filed on Oct. 7, 2014 and 61/956,199, filed on Jan. 7, 2014. The entire teachings of the above applications are incorporated herein by reference.

### BACKGROUND

Poor sanitation of the hands of the part of doctors and nurses cause the deaths of many thousands of patients every year. When doctors examine a patient and then go the next patient without properly washing or sanitizing their hands, they sometimes infect the next patient. One of the leading errors in hospital deaths is wound infection. Doctors are incredibly busy, and time spent washing hands is time not spent treating patients. Disinfectant dispensers placed in strategic places around hospitals has often been short of obtaining the desired results due to the apathy of doctors, and the people in charge of refilling dispensers, and can sometimes be empty.

### SUMMARY

The present invention can provide a simple hand sanitizing dispensing device that is able to sanitize effortlessly the same hand that grabs it, relatively conforming to the natural movement of the human arm and hand, without obstructing the functioning of other important instruments such as stethoscopes, etc., providing hand sanitation with one small movement of the user's arm and hand.

The present invention can provide a dispenser or dispensing device including a housing for containing a reservoir, having front and rear surfaces, and sides. The reservoir can store a substance to be dispensed. The housing can also include two large opposed spaced apart curved hand actuation surfaces at opposite sides of the housing for engaging opposite sides of the user's palm of the hand when squeezed, that are capable of moving relative to each other, towards and away from each other generally along an actuation path. A pump mechanism can be connected to and actuated by at least one of the curved hand actuation surfaces for pumping the substance from the reservoir. The pump mechanism can include a dispensing nozzle positioned in a generally central location of the housing between the two opposed curved hand actuation surfaces and aimed transversely outwardly relative to the front surface of the housing and actuation path of the two curved hand actuation surfaces, for ergonomic delivery of the substance to a central location of the user's palm of the hand while ergonomically squeezing the two opposed hand actuation surfaces.

In particular embodiments, the housing can have a generally flattened and rounded shape with rounded sides. The two opposed curved hand actuation surfaces can be spaced a distance apart from each other. The nozzle can be positioned about ⅓ to ½ of the distance from one of the actuation surfaces for ergonomically outwardly delivering the substance to the central location of the user's palm of the hand. Each of the two opposed curved hand actuation surfaces can peripherally extend at opposite sides of the housing between about 30° or 45° and 180° relative to a center of housing for allowing ergonomic gripping by the user's palm of the hand. The distance between the two opposed curved hand actuation surfaces can be about 2¼ to 4 inches apart. In some embodiments, the actuation path can be along at least in part a non-vertical axis with the two opposed curved hand actuation surfaces being located at opposite sides of the housing for squeezing by the user's palm of the hand. The non-vertical axis can be about horizontal to 45° horizontal. In one embodiment, the pump mechanism can be positioned along the non-vertical axis and include a suction passage extending from the pump mechanism that is directed downwardly into the reservoir to a bottom of the reservoir. In another embodiment, the two opposed curved hand actuation surfaces can be pivotably connected together for pivotable movement towards and away from each other to operate the pump mechanism. A securement arrangement can secure embodiments of the dispenser relative to the torso of the user.

The present invention can also provide a hand sanitizing dispenser or dispensing device including a housing for containing a reservoir having front and rear surfaces, and sides. The housing can have a generally flattened and rounded shape with rounded sides. The reservoir can store disinfectant to be dispensed. The housing can also include two large opposed spaced apart curved hand actuation surfaces at opposite sides of the housing for engaging opposite sides of the users palm of the hand when squeezed, that are capable of moving relative to each other, towards and away from each other generally along an actuation path. Each of the two opposed curved hand actuation surfaces can peripherally extended at opposite sides of the housing between about 60° and 180° relative to a center of housing. A pump mechanism can be connected to and actuated by at least one of the curved hand actuation surfaces for pumping the disinfectant from the reservoir. The pump mechanism can include a dispensing nozzle positioned in a generally central location of the housing between the two opposed curved hand actuation surfaces, and aimed transversely outwardly relative to the front surface of the housing and actuation path of the two curved and actuation surfaces for ergonomic delivery of the disinfectant to a central location of the user's palm of the hand, while ergonomically squeezing the two opposed curved hand actuation surfaces. A securement arrangement can be attached to the housing for securing and orienting the dispenser relative to the torso of the user, in which the actuation path is along at least in part a non-vertical axis with the two opposed curved hand actuation surfaces being located on opposite sides of the housing for ergonomic squeezing by the user's palm of the hand. The non-vertical axis can be about horizontal to 45° to horizontal.

In particular embodiments, the two opposed curved hand actuation surfaces can be pivotably connected together for pivotable movement towards and away from each other to operate the pump.

The present invention can also provide a method of dispensing a substance with a dispenser or dispensing device, including providing the dispenser with a housing having front and rear surfaces, and sides. The housing can contain a reservoir for storing the substance to be dispensed. Opposite sides of the user's palm of the hand can squeeze two large opposed spaced apart curved hand actuation surfaces at opposite sides of the housing. The two curved hand actuation surfaces can be capable of moving relative to each other, towards and away from each other generally on an actuation path. The substance can be pumped from the reservoir with a pump mechanism connected to and actuated by at least one of the curved hand actuation surfaces. The pump mechanism can include a dispensing nozzle positioned in a generally central location of the housing between the two opposed curved hand actuation surfaces, and aimed transversely outwardly relative to the front surface of the housing and actuation path of the two curved hand actuation surfaces, providing ergonomic delivery of the substance to a central location of the user's palm of the hand while ergonomically squeezing the two opposed curved hand actuation surfaces.

In particular embodiments, the housing can be provided with a generally flattened rounded shape with rounded sides. The two opposed curved hand actuation surfaces can be spaced a distance apart from each other, and the nozzle can be positioned about ⅓ to ½ of the distance from one of the actuation services for ergonomically outwardly delivering the substance to the central location of the user's palm of hand. Each of the two opposed curved hand actuation surfaces at opposite sides of the housing can peripherally extend between about 30° or 45° and 180° relative to a center of the housing for allowing ergonomic gripping by the user's palm of the hand. The housing can be provided with the distance between the two opposed curved hand actuation surfaces of about 2¼ the 4 inches apart. In some embodiments, the actuation path can be positioned along at least part of a non-vertical axis. The two opposed curved hand actuation surfaces can be located at opposite sides of the housing for squeezing by the user's palm of the hand. The non-vertical axis can be from about horizontal to 45° to horizontal. In one embodiment, the pump mechanism can be positioned along the non-vertical axis and a suction passage can extend from the pump mechanism with the passage being directed downwardly into the reservoir to a bottom of the reservoir. In another embodiment, the two opposed curved hand actuation surfaces can be pivotably connected together for pivotable movement towards and away from each other for operating the pump mechanism. Embodiments of the dispenser can be secured relative to the torso of the user with a securement arrangement.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a front schematic view of an embodiment of a dispenser or dispensing device in the present invention.

FIG. 2 is a drawing of a portion of a torso of a user having a securement mount, member or arrangement attached to the front of a clothing article.

FIG. 3 is a drawing showing the dispensing device of FIG. 1 attached to the torso of the user with a securement mount, member or arrangment.

FIG. 4 is a drawing showing hand operation of a dispensing device secure to the belt of a user.

FIG. 5 is a drawing showing an embodiment of a transparent dispensing device in the present invention.

FIG. 6 is a front view of another embodiment of a dispensing device in the present invention.

FIG. 7 is a rear view of the dispensing device of FIG. 6.

FIG. 8 is a front schematic view of a movable hand actuation member or surface of the housing in the present invention, and FIG. 9 is a perspective schematic view thereof.

FIG. 10 is a front schematic view of a main housing body in the present invention.

FIG. 11 is a schematic drawing showing an embodiment of a disposable reservoir or refill.

FIG. 12 is a drawing showing an ergonomically awkward position if attempting to apply vertical top/bottom pressure with the palm of the hand at about the front middle elevation of the torso.

FIG. 13 is a front view drawing showing an embodiment of a dispensing device in the present invention having securement arrangements that can orient the actuation path of opposed curved hand actuation surfaces along a generally lateral axis.

FIG. 14 is a schematic drawing of an embodiment of a dispensing device in the present invention capable of orienting the actuation path along a generally lateral axis.

FIG. 15 is a schematic drawing showing direction of forces in embodiments of the present invention.

FIG. 16 is a partial view of a torso of a user wearing another embodiment of a dispensing device in the present invention and FIG. 17 shows actuation by the user's hand.

FIG. 18 is a front schematic view of the dispensing device of FIG. 16.

FIG. 19 is front schematic drawing of an embodiment of a disposable or replaceable reservoir, refill or cartridge for the dispensing device of FIG. 18 in the present invention.

FIG. 20 is a front view of an embodiment of a housing or enclosure for the dispensing device of FIG. 18.

FIG. 21 is an enlargement of an embodiment of a contracting spring of the dispensing device engaging a pump mechanism.

FIG. 22 is a front schematic view of the dispensing device of FIG. 18 in a closed or compressed position.

FIG. 23 is a front view of another embodiment of a dispensing device in the present invention.

FIG. 24 is a front view of another embodiment of a dispensing device in the present invention.

FIG. 25 is a side schematic drawing of an embodiment of a dispensing device in the present invention.

FIGS. 26-29 show various features of another embodiment of a dispensing device in the present invention.

### DETAILED DESCRIPTION

A description of example embodiments of the invention follows.

Dispensing or spraying devices in the present invention can dispense a variety of different liquids, gels, creams or substances, including soaps, moisturizing creams, scented substances, and disinfectant or sanitizing substances, etc., for different purposes, but will be described for purposes of dispensing antibacterial disinfectant for use as a hand sanitizer. It is understood that the other uses are contemplated in the present invention.

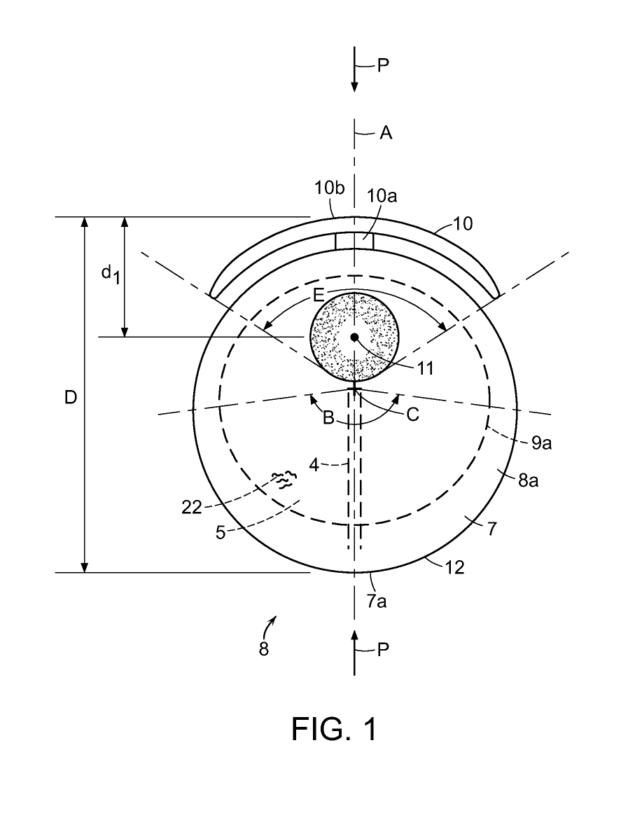

Referring to FIGS. 1-3, dispenser or dispensing device 8 can be a hand sanitizer or sanitizing device and can include a housing 8a having a main body 7 and a pump actuation member or surface 10. The housing 8a and main body 7 can have a generally rounded periphery or shape with rounded sides 12, and can have generally flattened front and rear surfaces or faces, that can have a slight curvature. The main body 7 can include a reservoir 5 for containing a disinfectant or sanitizing substance 22, such as a liquid, cream or gel. A pump mechanism or pump 4 such as a reciprocating suction pump as known in the art, can extend into the reservoir 5 for pumping disinfectant 22 from the reservoir 5, and out a lateral or transversely outwardly directed dispensing nozzle 11 extending through the front surface of the main body 7 of the housing 8a, at a generally central location of the housing 8a. The pump 4 can be aligned along a central axis A and include an actuation stem or rod 10a connected to the pump actuation member 10, which can have a large curved hand actuation surface 10b.

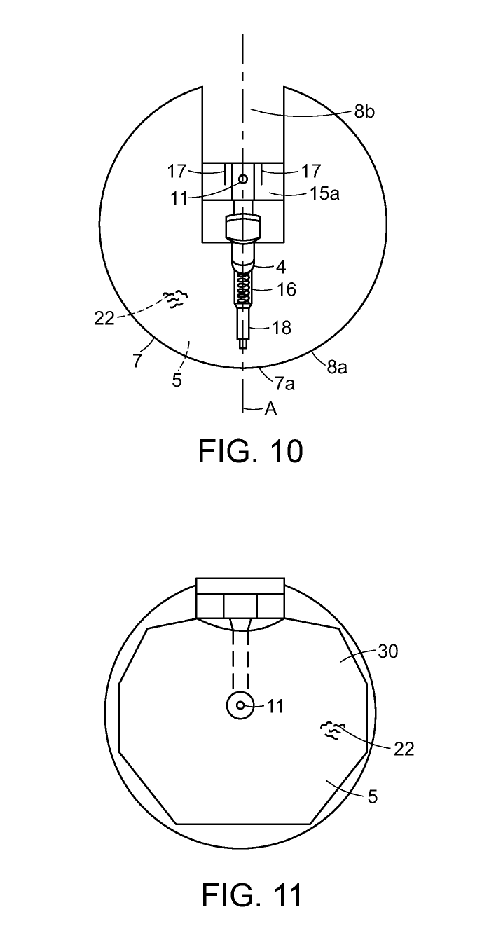

The curved hand actuation surface 10b can curve transversely across and extend on opposite sides of axis A, and can extend an angle E which can be about a 60° arc relative to a center C between the actuation surface 10b and an opposite large curved hand actuation surface 7a located on the opposite side of the housing 8a and main body 7. The opposite large curved hand actuation surface 7a can be formed by the curved side or periphery of the main body 7 of the housing 8a, and can curve transversely across and extend on opposite sides of axis A, extending an angle B which can be about a 160° to 180° arc relative to center C. As a result, the two large curved hand actuation surfaces 10b and 7a can be located on opposite sides of the housing 8a along axis A, and spaced a nominal or noncompressed distance D apart from each other. The distance D can often range from about 2¼ to 4 inches apart, and often can be about 2½ to 3½ inches. The nozzle 11 can be positioned a distance d₁ from one of the curved hand actuation surfaces, such as surface 10b, which can be about ⅓ to ½ the distance D between surfaces 10b and 7a. This can allow a user 6 squeezing dispensing device 8 with the palm of the hand 6a along an actuation path that coincides with axis A, on opposed spaced apart curved hand actuation surfaces 10a and 7a with opposed pressure or force P on the actuation path, to depress the surface 10b relative to main body 7 and surface 7a, to operate pump 4. The nozzle 11 can expel, eject or spray the disinfectant 22 outwardly transversely or laterally into about the center of the palm of hand 6a quickly in a swift ergonomic one handed motion, action or movement. A spring 16 (such as in FIG. 10) within pump 4 can return the stem 10a and surface 10b to its original position in a reciprocating manner when pressure P is released by hand 6a. Positioning the nozzle 11a distance d₁ that is about ⅓ to ½ the distance D from surface 10b is at a location that provides delivery of the disinfectant 22 to the center of the hand 6a. The large angle or arc opposed curved hand actuation surfaces 10b and 7a allow easy tactile grasping or grabbing of the dispensing device 8 during use, which can allow the user 6 to operate by feel without looking A single squeeze by the hand 6a can be sufficient to spray the desired amount of disinfectant 22, but if needed, hand 6a can alternately squeeze and release dispensing device 8 and surfaces 10b and 7a to reciprocate pump 4.

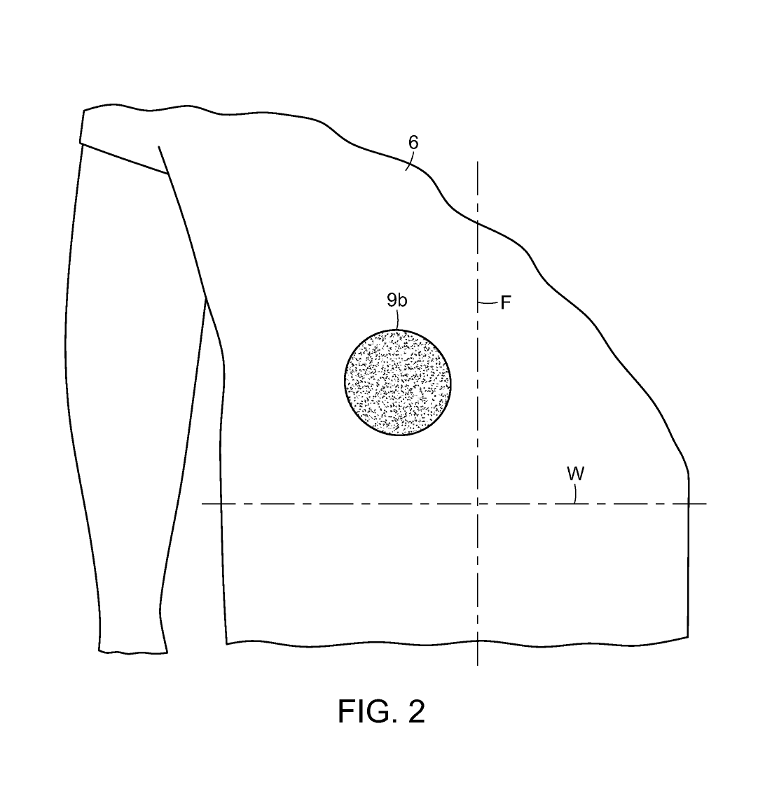

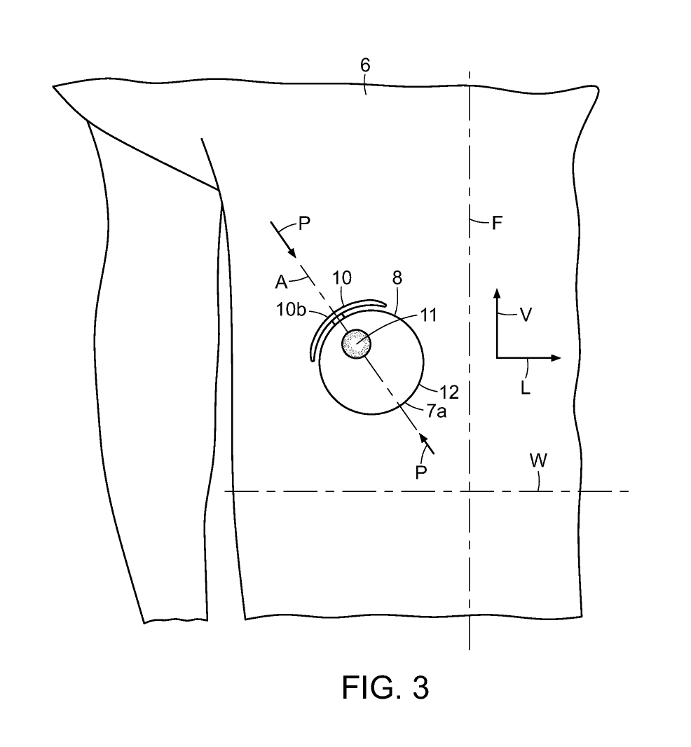

The rear face or surface of the main body 7 of the housing 8a can have an area of a hook and loop fastener half or component, for example hooks secured thereon, forming a securement member 9a (FIG. 1), which can mate or engage with an area of the other mating half or component of the hook and loop fastener, for example loops, forming a mating securement member 9b (FIG. 2) that can be attached to the clothing or shirt of the user 6. This can secure the dispensing device 8 to the torso of the user 6 for easy access and ergonomic use (FIG. 3). The dispensing device 8 can be positioned on the clothing above the waistline W on the front of the user's 6 torso, and can be slightly offset from the upright or vertical torso centerline F of the user 6. The side of the dispenser 8 can be offset from axis F by about ¼ to ½ the width of the dispenser 8. The actuation path for surfaces 10b and 7a along axis A can be positioned at an angle between the vertical V and lateral L or horizontal axes, such as at about 45° to horizontal, which can provide comfortable operation. Such location and positioning can provide a location for the dispensing device 8 that doesn't interfere with the user's 6 activities or equipment, for example a stethoscope, if used by health care providers, while also providing quick easy one handed ergonomically oriented access and operation by the user's 6 hand 6a.

The actuation path along axis A can be positioned horizontally or vertically (axis L or V), or angles in between, for example, about or near 60°, 45°, 30°, 15°, etc. depending upon the situation at hand. When the dispensing device 8 is positioned low relative to the user's 6 torso, such as at the waistline W, the axis A can be positioned along the vertical axis V and provide ergonomic use. However, as the location of the dispensing device 8 is moved upwardly above the waistline W, the axis A can be moved at an angle between the vertical V and horizontal or lateral axis L, such as at an oblique angle which can be about 45° to horizontal to provide comfortable or ergonomic use. At certain heights above waistline W, the axis A can be positioned horizontally on axis L, to provide comfortable or ergonomic use, and can be positioned over or on central axis F of the torso.

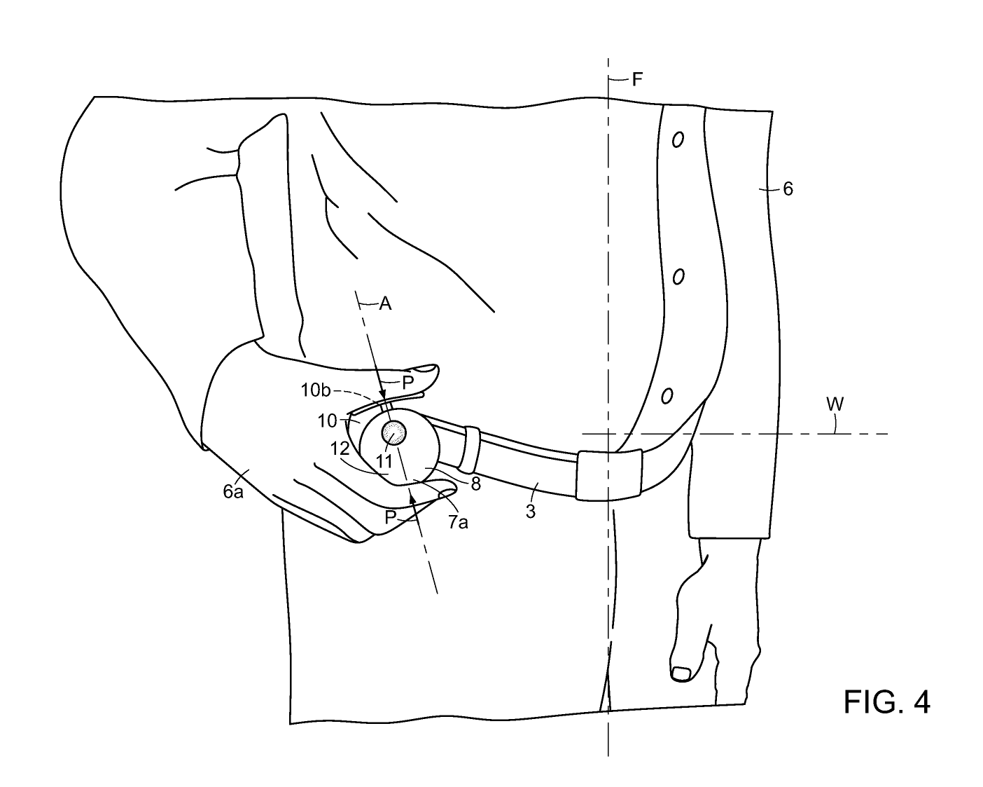

Referring to FIG. 4, the dispensing device 8 can be secured to the waistline W of the user 6 on a belt 3, such as by securement members 9a and 9b of hook and loop fastener, offset from axis F on the hip or side of the user 6. In other embodiments, securement member 9a on dispensing device 8 can be a clip that is clipped onto the belt 3 or the top of the user's 6 pants, which can serve as the corresponding securement member 9b. The actuation path along axis A can be along vertical axis V or near vertical as shown. FIG. 4 shows how the palm of the user's 6 hand 6a can squeezably engage opposed curved hand actuation surfaces 10b and 7a, squeezing on opposite sides of the dispensing device 8 along the actuation path on axis A and applying opposed force or pressure P along the axis A for operating pump 4. This can dispense disinfectant 22 outwardly in a transverse, lateral or perpendicular direction relative to axis A and the front face or surface of the housing 8a of dispensing device 8, from a generally centrally located dispensing nozzle 11, for directing the disinfectant 22 into about the center of the palm of the user's 6 hand 6a. This can be accomplished with a single motion (one pump) with a single hand 6a.

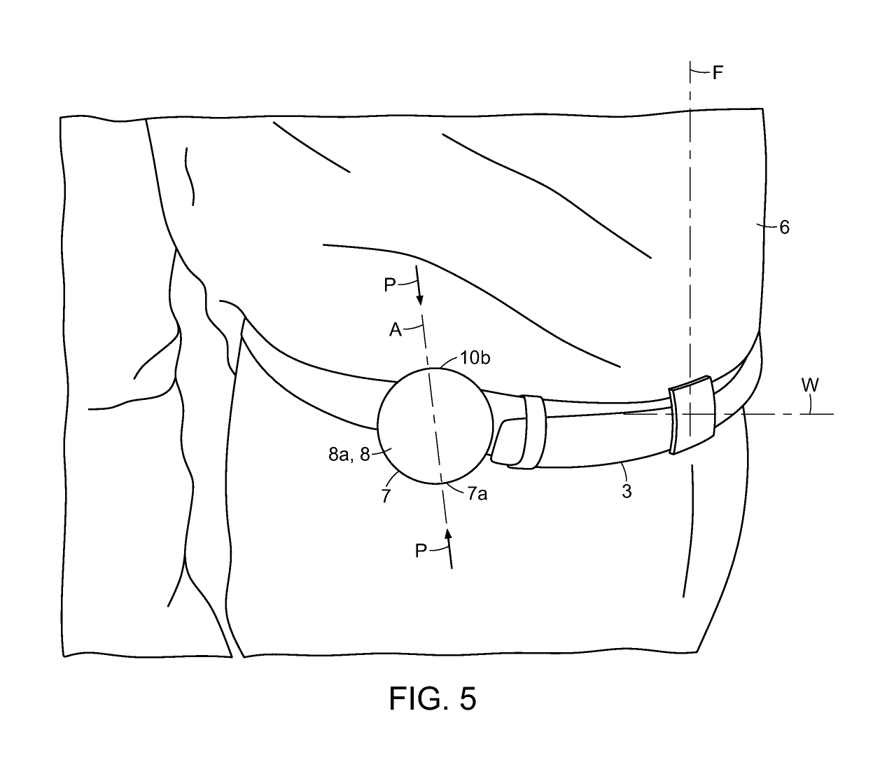

FIG. 5 depicts another embodiment of a dispensing device 8 which can have transparent portions of the housing 8a. The opposed spaced apart curved hand actuation surfaces 10b and 7a can be generally on or within the main body 7, and can operate in a similar manner as in FIG. 4. FIGS. 3-5 show positioning for right handed use, and the dispensing device 8 can be positioned on the opposite side or orientated relative to the torso for left hand use.

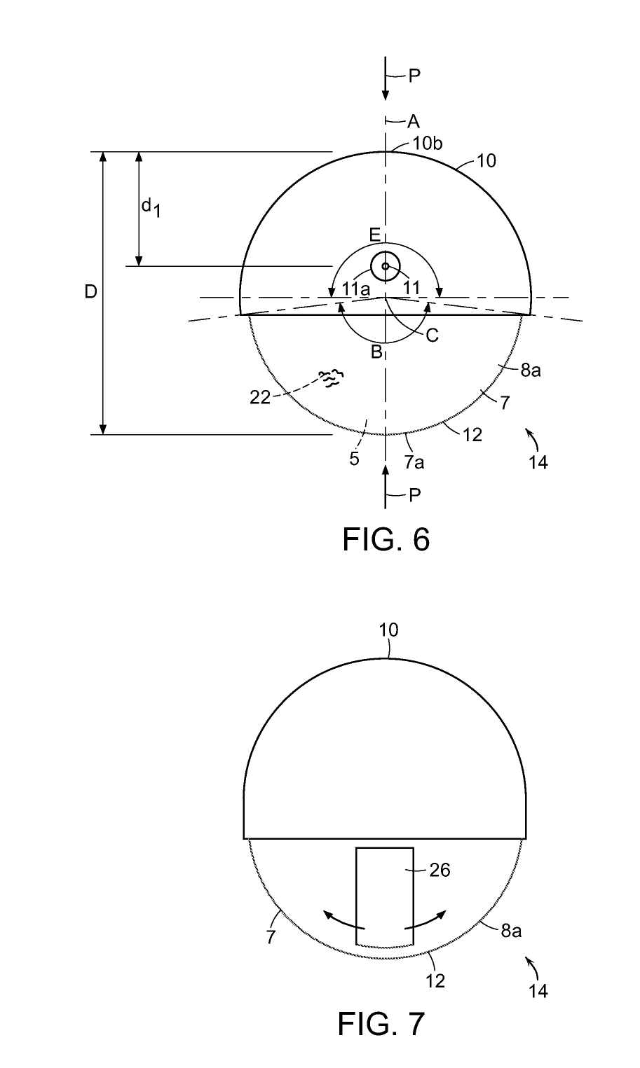

Referring to FIGS. 6-9, dispenser or dispensing device 14 is another embodiment in the present invention which differs from dispensing device 8 in that the pump actuation member or surface 10 can extend closely over a portion of the main body 7, for example about half or slightly more than half as shown. The pump actuation member 10 can have the form of a flattened hollow generally semicircular shell, or half disk, which reciprocates and moves relative to or over main body 7 along an actuation path on axis A, for actuating pump 4. The curved hand actuation surface 10b can curve transversely across and extend on opposite sides of axis over an angle E which can be about a 180° arc relative to center C. The opposite curved hand actuation surface 7a can curve transversely across and extend on opposite sides of axis A for an angle B, which can be about a 160° to 180° arc relative to center C. Nozzle 11 can be positioned almost at the center C, where d₁ can be about ⅜ the distance D from surface 10b. Closely fitting member 10 over the main body 7 can form a smooth simple ascetically pleasing flattened generally rounded shape that is less likely to catch or tangle with tubes, cords and wires of equipment. The generally central location of dispensing nozzle 11 can allow or provide spraying, expulsion, ejection or delivery of a liquid, gel, substance, cream or disinfectant 22 to the center of the palm of the hand 6a. The rear face or surface of the main body 7 of the housing 8a can include a securement member 26. In some embodiments, the securement member 26 can be hook and loop fastener, and in other embodiments can be a securement clip. Securement member 26 can pivot as shown, for allowing adjustment to a desired orientation, and can be secured on a belt 3, or clothing. The two large semicircular curved hand actuation surfaces 10b and 7a can be easily tactilely felt, grasped and slidably compressed towards each other along the actuation path on axis A without looking.

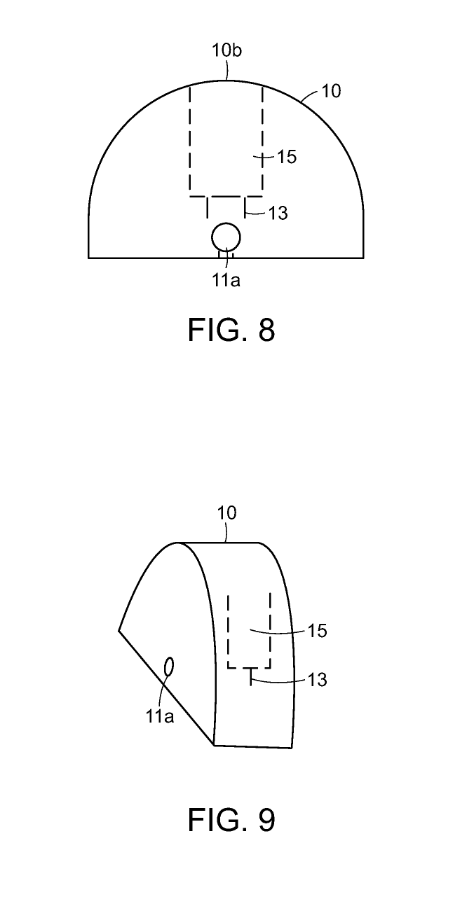

Referring to FIGS. 8-10, the pump 4 can be aligned on axis A and include a suction mechanism, passage or tube 18 extending into the reservoir 5 in the main body 7. A coil compression spring 16 can cause or allow the pump 4 to reciprocate for continual pumping or spraying. A portion of the pump 4 can extend into a rectangular guide recess, slot or opening 8b and into a block or member 15a therein that slidably engages an upright rectangular block or member 15 extending to the roof within hand actuation member 10, for operating pump 4 when compressed. Pins 13 extending from block 15 can engage sleeves 17 in block 15a. The block 15a can include dispensing nozzle 11 which can align with an orifice or opening 11a in the hand actuation member 10. Since the nozzle 11 is positioned within hand actuation member 10, the position of nozzle 11 can move towards center C when compressed. Dispensing device 14 can operate in a similar manner as dispensing device 8.

FIG. 11 depicts an embodiment of a disposable cartridge or refill 30 for dispensing devices 8 and 14, containing a dispensing substance 22 such as disinfectant. The refill 30 can include a housing or can include a bag filled with disinfectant 22. The refill 30 can be replaced when the disinfectant 22 is used up.

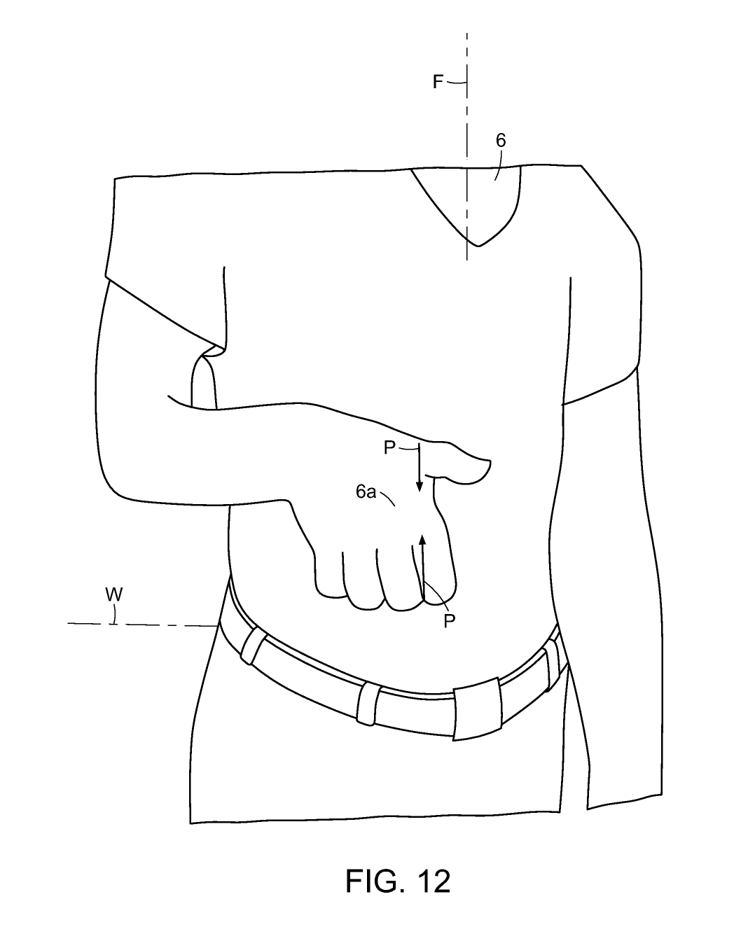

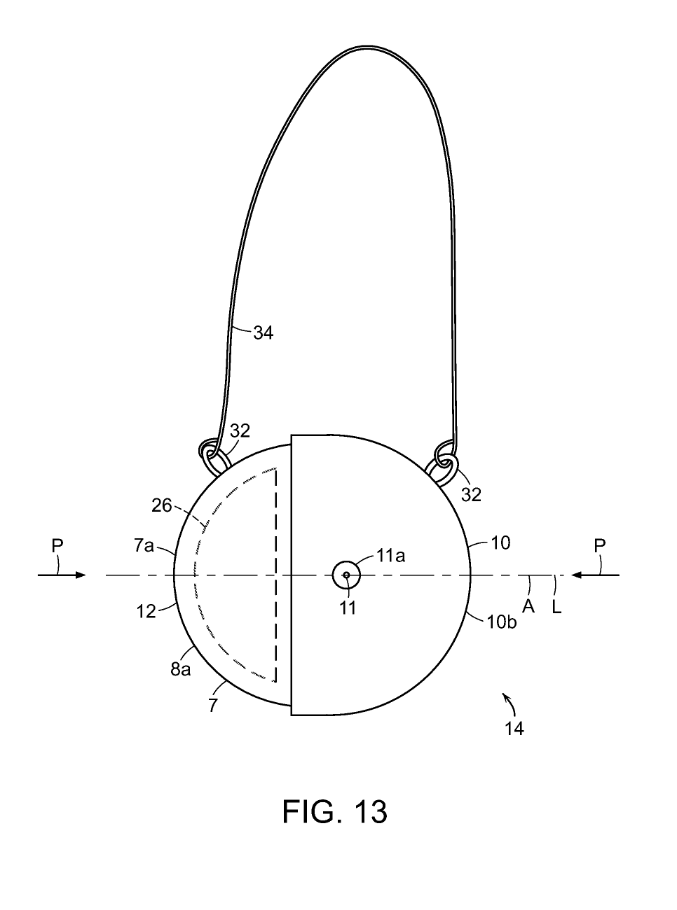

FIG. 12 shows that ergonomic awkwardness or discomfort can occur for a dispensing device that is positioned well above the waistline W and the actuation path is vertical, where the user's 6 hand 6a must exert force or pressure P from vertically opposed upper and lower positions inline or parallel to axis F. Applying such pressure P vertically at such a location can be uncomfortable or awkward. As a result, dispensing device 14 can be positioned with the actuation path on axis A aligned along a horizontal or lateral axis L (FIG. 13), which can provide more comfortable or ergonomic gripping and compressing of dispensing 14 by hand 6a with opposed lateral force P on axis A. The dispensing device 14 can be secured in this lateral position by securement member 26, or can be hung from the neck of the user 6 with a cord 34 that can be attached to fixtures 32 on the hand actuation member 10 and the main body 7. The angle at which axis A is positioned can be varied, for example by the position of fixtures 32. A cord 34 can also be attached to dispensing device 8 for similar orientation.

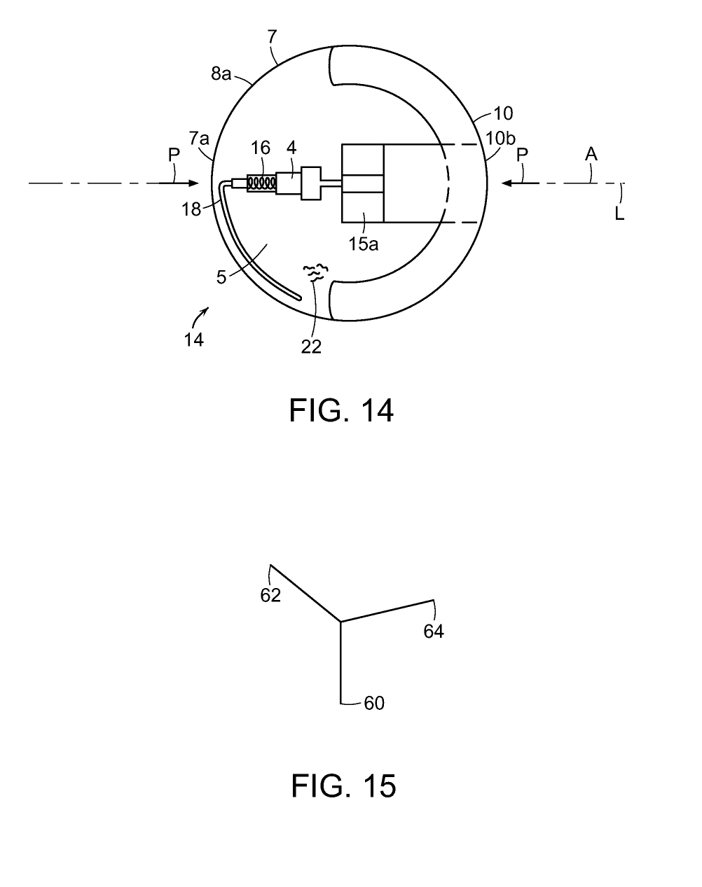

Referring to FIG. 14, when dispensing device 14 is employed for lateral orientation with axis A along the horizontal or lateral axis L, the suction tube 18 of pump 4 can be bent downwardly for example at least 90°, to angle or curve downwardly to the bottom of the reservoir 5 in order to efficiently suction and dispense most or all of the liquid, gel, cream, substances or disinfectant 22 in the reservoir 5. The hand actuation member 10 can be disengaged from the main body 7 and the replaced in reverse position so that the suction tube 18 angles or bends into the opposite side of the reservoir 5. This can allow left hand and right hand positioning of a laterally positioned dispensing device 14. The hand actuation member 10 can include the nozzle 11 which allows this right/left switch to be made.

FIG. 15 depicts the X, Y, Z force direction principle in embodiments of dispensing devices in the present invention, where disinfectant 22 can be suctioned perpendicularly and expelled transversely, laterally or horizontally either at right or left angles of the palm of the hand 6a that is exerting pressure P. Suction is designated at 60, expulsion at 62, and lateral force of pressing 64 by hand 6a.

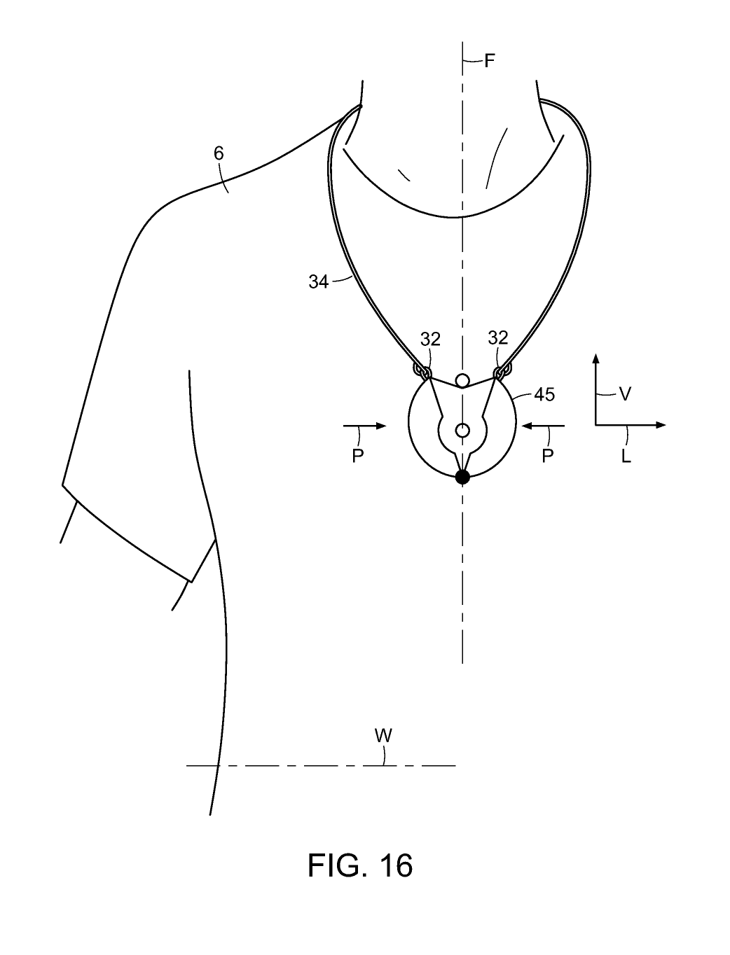

FIGS. 16-22 depict another embodiment of a dispenser or dispensing device 45 which can have an actuation path along the horizontal or lateral axis L for lateral pressure or force P by the palm of the user's 6 hand 6a. Dispensing device 45 can be secured relative to the torso of the user 6 above the waistline W by a cord 34 hanging from the neck. The cord 34 can be elastic and can be pulled downwardly while applying lateral pressure P on axis L with the hand 6a as seen in FIG. 17.

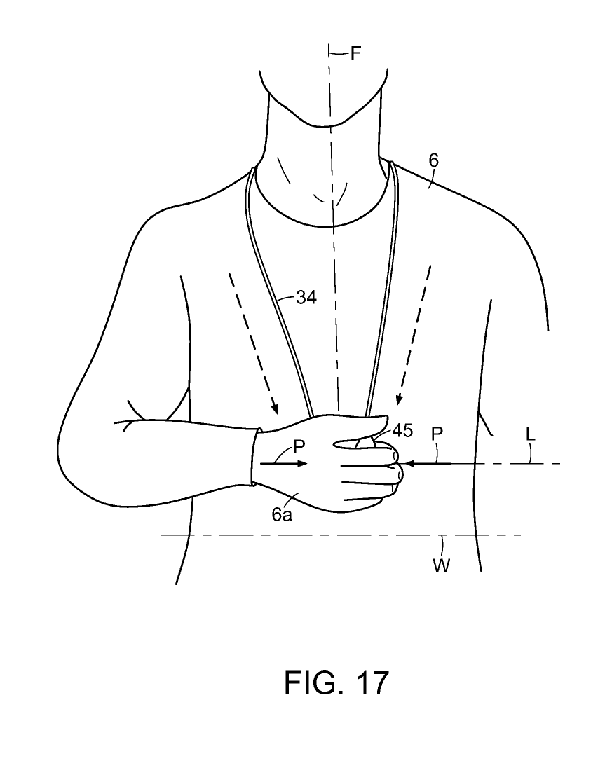

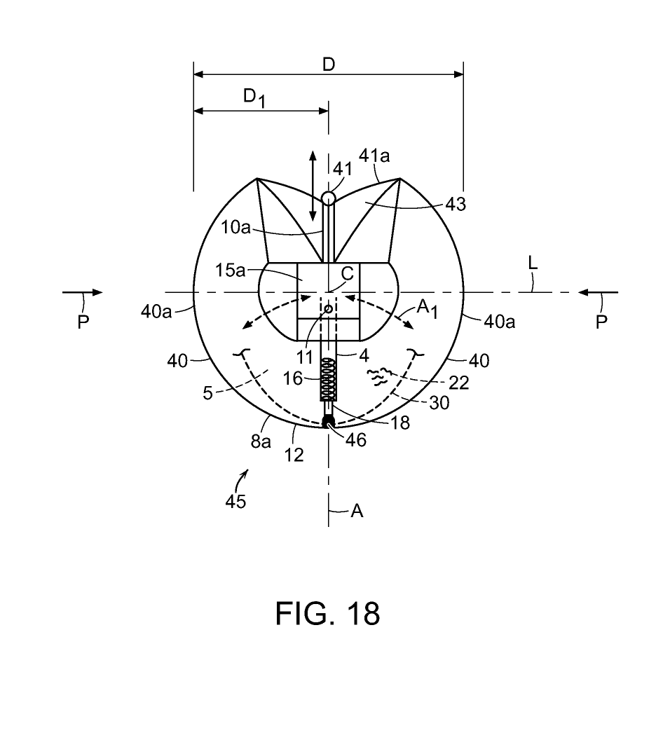

Referring to FIGS. 18-22, the dispensing device 45 can have a housing 8a with two large lateral rotating or pivoting curved hand actuation members, sides, halves or portions 40 that are pivotably secured to each other by a rotatable pivot point, joint or axis 46 located at the lower or bottom end along upright or vertical central axis A. The large spaced apart curved opposed hand actuation surfaces 40a of sides 40 on opposite sides of housing 8a can extend about 140° relative to center C peripherally in an arc for allowing easy tactile ergonomic gripping by the palm of the user's 6 hand 6a. Other suitable angles of arc length can be employed. A bent leaf spring 41a having a downwardly bent central portion or vertex 41 that is bent towards pivot point 46 can be secured to and between the two sides 40 at the top or opposite end of housing 8a from pivot point 46. The leaf spring 41a can resiliently bias the two sides 40 outwardly away from each other to move, pivot or rotate the sides 40 outwardly by resilient force of leaf spring 41a when released after being laterally squeezed together under opposed pressure P along axis L by the user's 6 hand 6a. This can provide or allow reciprocating pivoting or rotating movement of the sides 40 about pivot point 46 along an actuation path A₁, that can be in an arc relative to pivot point 46. The actuation path A₁ can have a tangent point along or parallel to horizontal or lateral axis L, and can laterally or transversely extend across axis A. In some embodiments, a securement member 9a such as hook and loop fastener can be secured to the rear of one of the sides 40 for securement to the user 6.

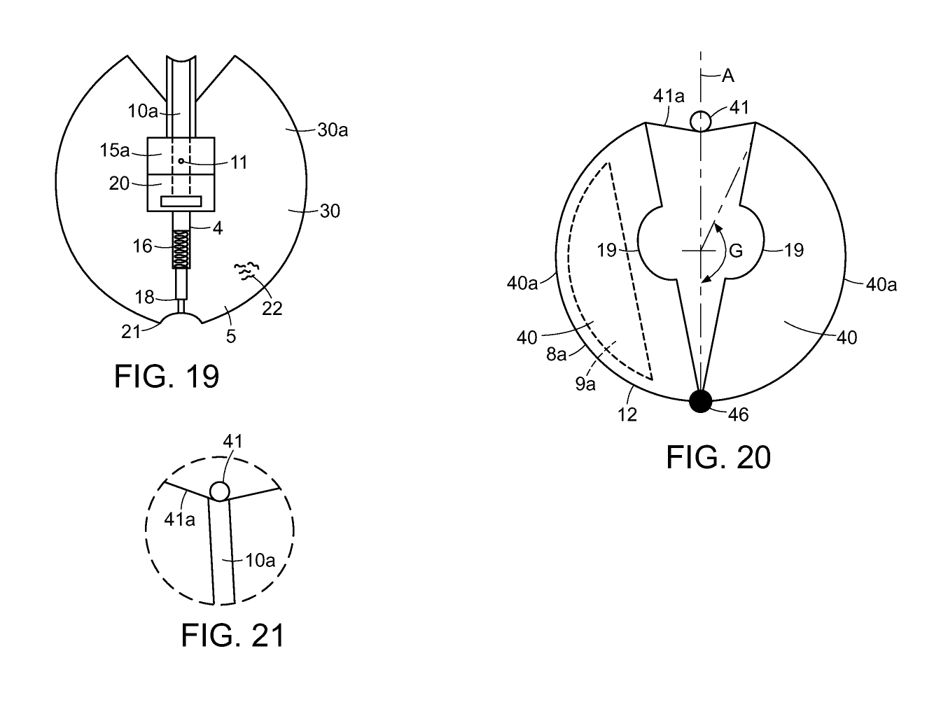

A disposable cartridge or refill 30 (FIG. 19), containing a liquid, gel, cream, substance or disinfectant 22, can be housed within housing 8a and can include a pump mechanism or pump 4 similar to those previously described, that is positioned or extended within a reservoir 5 on axis A. The refill 30 can be smaller than housing 8a when sides 40 are compressed, for example, about ½ inch smaller, allowing sides 40 of the housing 8a to pivotably reciprocate without or with little interference by the refill 30. In one embodiment, the refill 30 can be rigid, and in other embodiments can have flexible portions. The sides 40 of the housing 8a can be semi-rigid, but can be rigid in other embodiments. The pump 4 in the refill 30 can have a sliding block or member 15a within a rectangular recess or track 20 that can be operated by a rod or stem 10a, and can include an outwardly directed dispensing nozzle 11 that is on and transversely or perpendicularly directed laterally relative to axis A. The nozzle 11 can move up and down on member 15a and can be located a distance D₁ that is about ½ the distance D between the hand actuation surfaces 40a of sides 40. The nozzle 11 can also be generally near the center C vertically on axis A. The suction tube 18 can extend below spring 16 to or near the bottom of the reservoir 5. The refill 30 can have a notch or recess 21 at the bottom periphery of the refill housing 30a for fitting around or engaging pivot point 46. The vertex 41 of spring 41a can engage a notch or recess in the top or upper end of stem 10a, thereby sandwiching, trapping or securing the refill 30 within housing 18a with capture structures between the pivot point 46 and the vertex 41. Compression of the sides 40 towards each other can bend and move the vertex 41 of spring 41a downwardly or against the stem 10a and member 15a as seen by the arrows, which can operate the pump 4 and spray, eject or expel disinfectant 22 laterally outwardly from nozzle 11. The spring 41a can move downwardly into a generally conic shaped opening between sides 40. The sides 40 can have opposed central notches 19 for fitting around nozzle 11 and can be large enough to allow for movement of the nozzle 11, along axis A without interfering with the spray of disinfectant 22.

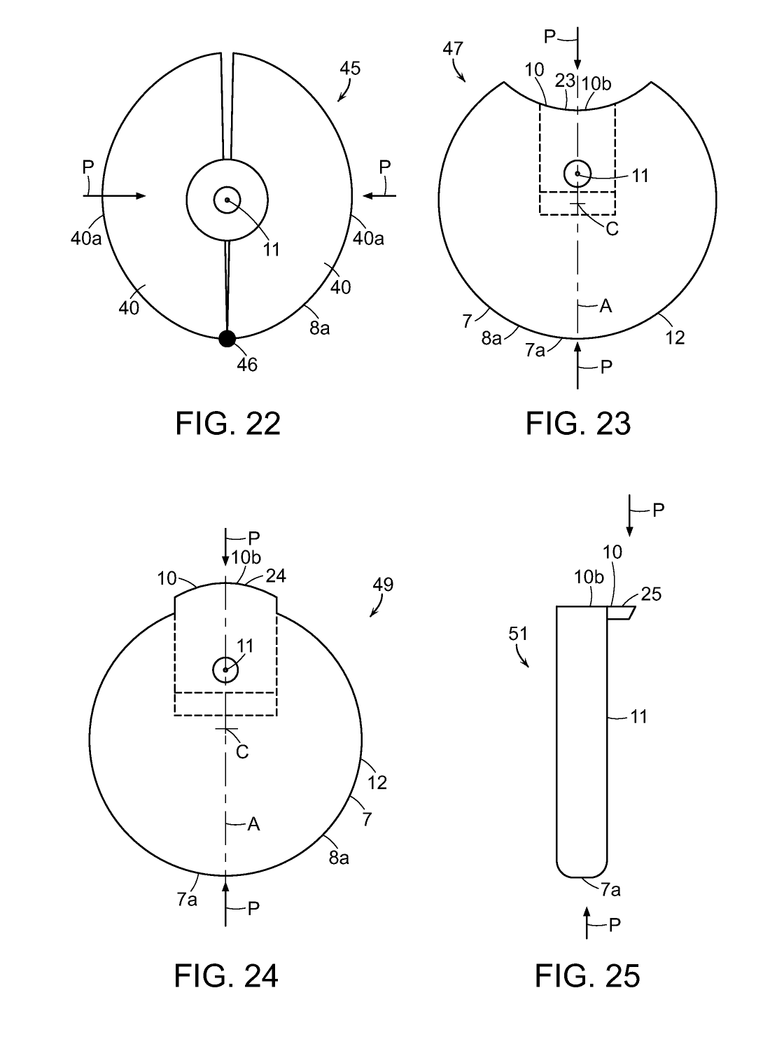

The laterally activated actuation path A₁ of dispensing device 45 can be more ergonomically comfortable when the dispensing device 45 is worn close to the upright torso centerline F of the user 6 and/or high relative to the torso near the neck, than a vertical actuation path, due to more comfortable hand and arm positioning. In some embodiments, the dispensing device 45 can be positioned for activation or compression with opposed vertical pressure P if desired. Dispensing device 45 having large opposed curved hand actuation surfaces 40a on opposite sides of the housing 8a and a generally central nozzle 11 can allow easy one handed operation which can be without looking at the device, but merely by tactile feeling and grasping the device 45. FIG. 22 depicts dispensing device 45 in a compressed position.

FIG. 23 depicts another embodiment of a dispensing device 47 which can differ from dispensing device 8 in that the housing 8a can have a locating notch or indentation 23 for allowing the user 6 to locate a concave hand actuation surface 10b of a pump actuation member 10. The hand actuation surface 10b can extend for about 30° relative to center C and hand actuation surface 7a can extend about 180°.

FIG. 24 depicts another embodiment of a dispensing device 49 which can differ from dispensing device 8 in that pump actuation member 10 can have a curved hand actuation surface 10b that is located on the outer edge of a member 10 having a constant width. The pump actuation member 10 can have a curved surface 10b with a width that extends into main body 7, and a portion 24 can extend above the main body 7 to provide tactile guidance to the user 6 for gripping the dispensing device 49 from opposed curved hand actuation surfaces 10b and 7a. Hand actuation surface 10b can extend in a peripheral arc about 30° from center C, and hand actuation surface 7a can extend in a peripheral arc about 180°.

FIG. 25 is a side view of another dispensing device 51 which differs from dispensing device 8 in that the pump actuation member 10 can have a lateral protrusion 25 extending laterally outwardly. This can allow the palm of the user's 6 hand 6a opposite to the fingers to easily tactilely identify and engage the protrusion 25 to operate the pump 4.

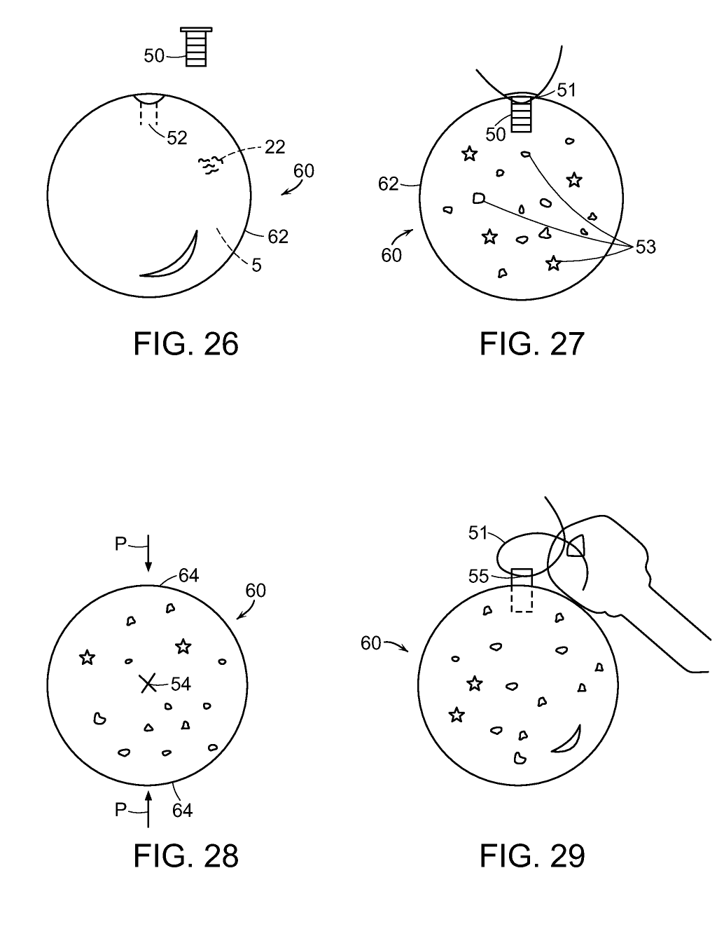

FIGS. 26-29 show another embodiment of a dispenser or dispensing device 60 in the present invention having a hollow generally round or spherical housing 62, such as formed with flexible plastic or rubber, that has a reservoir 5 for containing cream, liquid, gel, substances or disinfectant 22 therein. The housing 62, can have a fill inlet 52 for refilling the housing 62 and can be closed by a threaded cap 50. A cord or ring 51 can be attached to the cap 50 to allow for securement to desired items, such as a backpack, bag, belt or purse, or for the attachment of keys 55 if used as a key ring. Decorative items, figurines or objects 53, such as moon and star shaped figures can be floating within the reservoir 5 with the disinfectant 22, for decorative purposes. A dispensing outlet, hole, opening or orifice 54 can be formed through the housing 62 for dispensing, ejecting or expelling disinfectant 22 when the flexible housing 62 is squeezed on opposite sides of the housing 62 on large curved opposed hand actuation surfaces 64 by opposed pressure P by the user's 6 hand 6a along an actuation path, which can be on an axis A, such as previously described, to laterally dispense disinfectant 22. The orifice 54 can be a crisscross shaped cut through the housing 62 as shown. In other embodiments, the orifice 54 can be L or T shaped cuts, a series of radially extending cuts, or can include a check valve, such as a duck bill valve. Housing 62 can be in the shape and/or configuration of sporting good balls, such as baseballs, footballs, soccer balls, basketballs, golf ball, etc., or other rounded or curved objects such as an egg. It is understood that other suitable shapes, including shapes with straight sides can be used.

While this invention has been particularly shown and described with references to example embodiments thereof, it will be understood by those skilled in the art that various changes in form and details may be made therein without departing from the scope of the invention encompassed by the appended claims.

For example, it is understood that embodiments of dispensing devices in the present invention can be used in different orientations. Various features in the embodiments shown or described can be combined together or omitted. In addition, dimensions can vary, depending upon the situation at hand. Although round or generally round shapes have been shown, other suitable shapes can be used.

What is claimed is:

1. A dispenser comprising:
a housing for containing a reservoir, having front and rear surfaces, and sides, the reservoir for storing a substance to be dispensed, the housing also including two large opposed spaced apart curved hand actuation surfaces at opposite sides of the housing for engaging opposite sides of a user's palm of the hand when squeezed, that are capable of moving relative to each other, towards and away from each other generally along an actuation path; and
a pump mechanism connected to and actuated by at least one of the curved hand actuation surfaces for pumping the substance from the reservoir, the pump mechanism including a dispensing nozzle positioned in a generally central location of the housing between the two opposed curved hand actuation surfaces and aimed transversely outwardly relative to the front surface of the housing and actuation path of the two curved hand actuation surfaces, for ergonomic delivery of the substance to a central location of the user's palm of the hand while ergonomically squeezing the two opposed curved hand actuation surfaces.

2. The dispenser of claim 1 in which the housing has a generally flattened rounded shape with rounded sides.

3. The dispenser of claim 2 in which the two opposed curved hand actuation surfaces are spaced a distance apart from each other, and the nozzle is positioned about ⅓ to ½ of said distance from one of the actuation surfaces for ergonomically outwardly delivering the substance to the central location of the user's palm of the hand.

4. The dispenser of claim 3 in which each of the two opposed curved hand actuation surfaces peripherally extend at opposite sides of the housing between about 45° and 180° relative to a center of the housing for allowing ergonomic gripping by the user's palm of the hand.

5. The dispenser of claim 4 in which the distance between the two opposed curved hand actuation surfaces is about 2¼ to 4 inches apart.

6. The dispenser of claim 1 in which the actuation path is along at least in part a non-vertical axis with the two opposed curved hand actuation surfaces being located at opposite sides of the housing for squeezing by the user's palm of the hand, the non-vertical axis being about horizontal to 45° to horizontal.

7. The dispenser of claim 6 in which the pump mechanism is positioned along the non-vertical axis and includes a suction passage extending from the pump mechanism that is directed downwardly into the reservoir to a bottom of the reservoir.

8. The dispenser of claim 1 in which the two opposed curved hand actuation surfaces are pivotably connected together for pivotable movement towards and away from each other to operate the pump mechanism.

9. The dispenser of claim 1 further comprising a securement arrangement for securing the dispenser relative to the torso of the user.

10. A hand sanitizing dispenser comprising:
a housing for containing a reservoir having front and rear surfaces, and sides, the housing having a generally flattened rounded shape with rounded sides, the reservoir for storing disinfectant to be dispensed, the housing also including two large opposed spaced apart curved hand actuation surfaces at opposite sides of the housing for engaging opposite sides of a user's palm of the hand when squeezed, that are capable of moving relative to each other, towards and away from each other generally along an actuation path, each of the two opposed curved hand actuation surfaces peripherally extending at opposite sides of the housing between about 60° and 180° relative to a center of the housing;
a pump mechanism connected to and actuated by at least one of the curved hand actuation surfaces for pumping the disinfectant from the reservoir, the pump mechanism including a dispensing nozzle positioned in a generally central location of the housing between the two opposed curved hand actuation surfaces and aimed transversely outwardly relative to the front surface of the housing and actuation path of the two curved hand actuation surfaces for ergonomic delivery of the disinfectant to a central location of the user's palm of the hand while ergonomically squeezing the two opposed curved hand actuation surfaces; and
a securement arrangement attached to the housing for securing and orienting the dispenser relative to the torso of the user, in which the actuation path is along at least in part a non-vertical axis, with two opposed curved hand actuation surfaces being located at opposite sides of the housing for ergonomic squeezing by the user's palm of the hand, the non-vertical axis being about horizontal to 45° to horizontal.

11. The dispenser of claim 10 in which the two opposed curved hand actuation surfaces are pivotably connected together for pivotable movement towards and away from each other to operate the pump.

12. A method of dispensing a substance with a dispenser comprising:
providing the dispenser with a housing having front and rear surfaces, and sides, the housing containing a reservoir for storing the substance to be dispensed;
with opposite sides of a user's palm of the hand, squeezing two large opposed spaced apart curved hand actuation surfaces at opposite sides of the housing, the two curved hand actuation surfaces being capable of moving relative to each other, towards and away from each other generally on an actuation path; and
pumping the substance from the reservoir with a pump mechanism connected to and actuated by at least one of the curved hand actuation surfaces, the pump mechanism including a dispensing nozzle positioned in a generally central location of the housing between the two opposed curved hand actuation surfaces and aimed transversely outwardly relative to the front surface of the housing and actuation path of the two curved hand actuation surfaces, providing ergonomic delivery of the substance to a central location of the user's palm of the hand while ergonomically squeezing the two opposed curved hand actuation surfaces.

13. The method of claim 12, further comprising providing the housing with a generally flattened rounded shape with rounded sides.

14. The method of claim 13 further comprising spacing the two opposed curved hand actuation surfaces a distance apart from each other and positioning the nozzle about ⅓ to ½ of said distance from one of the actuation surfaces for ergonomically outwardly delivering the substance to the central location of the user's palm of the hand.

15. The method of claim 14 further comprising peripherally extending each of the two opposed curved hand actuation surfaces at opposite sides of the housing between about 45° and 180° relative to a center of the housing for allowing ergonomic gripping by the user's palm of the hand.

16. The method of claim 15 further comprising providing the housing with the distance between the two opposed curved hand actuation surfaces of about 2¼ to 4 inches apart.

17. The method of claim 12 further comprising positioning the actuation path along at least part of a non-vertical axis, the two opposed curved hand actuation surfaces being located at opposite sides of the housing for squeezing by the user's palm of the hand, the non-vertical axis being from about horizontal to 45° to horizontal.

18. The method of claim 17 further comprising positioning the pump mechanism along the non-vertical axis and extending a suction passage from the pump mechanism and directing the passage downwardly into the reservoir to a bottom of the reservoir.

19. The method of claim 11 further comprising pivotably connecting the two opposed curved hand actuation surfaces together for pivotable movement towards and away from each other for operating the pump mechanism.

20. The method of claim 11 further comprising securing the dispenser relative to the torso of the user with a securement arrangement.
